(19) United States
(12) Patent Application Publication
(10) Pub. No.: US 2006/0121490 A1
(43) Pub. Date: Jun. 8, 2006

(54) Host cell and polypeptide arrays and use thereof

(76) Inventor: Wei-Wu He, Silver Spring, MD (US)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 11/000,909

(22) Filed: Dec. 2, 2004

(51) Int. Cl. C40B 40/08; C40B 40/10

(52) U.S. Cl. 435/6; 435/7.1

(57) ABSTRACT

The present invention provides articles of manufacture (such as host cell and polypeptide arrays) and methods of use for screening and identifying agents that react with polypeptides. These are useful in a variety of applications, including for diagnostic, therapeutic, drug discovery, and forensic purposes.

### DESCRIPTION OF THE INVENTION

The present invention provides articles of manufacture (such as host cell and polypeptide arrays) and methods of their use for screening and identifying agents that react with polypeptides. These are useful in a variety of applications, including for diagnostic, therapeutic, drug discovery, and forensic purposes.

Any type of agent that reacts with a polypeptide can be utilized in accordance with the present invention. Agents can be specific-binding partners, such as antibodies, receptor ligands, aptamers, polypeptides, and other binding molecules that directly attach (“bind”) to polypeptides. Agents can also be enzymes (polypeptides, ribozymes, etc) that modify polypeptides (e.g., a kinase that phosphorylates a protein substrate). An agent can be comprised of any material that is capable of binding to a polypeptide, including, chemical compounds; biomolecules, such as polypeptides (amino acids), lipids, nucleic acids (nucleotides), and carbohydrates; inorganic molecules; organic molecules; and combinations thereof.

In certain embodiments of the present invention, the articles of manufactures can be used to screen and identify antibodies that bind to polypeptides. Antibodies are often used for therapeutic or diagnostic purposes, even when the complete set of antigens with which they interact is not entirely known. When antibodies are generated against antigens, the resulting antibodies are generally characterized as being specific for that antigen (e.g., binding to a defined amino acid sequence within it). However, it is well known that even specific antibodies can cross-react with unrelated antigens. For instance, unrelated antigens can comprise substantially identical epitopes. In addition, differentially-spliced variants may be expressed in multiple tissues, resulting in the appearance of a shared domain (epitope) in tissues and cells other than the target site. This cross-reactivity can be a significant problem when the antibody is used for the therapeutic purposes. For example, when the antibody is used to deliver a toxic agent to a cell expressing the polypeptide of interest, if the antibody recognizes other targets cells in the body, then its use could have unexpected deleterious effects. The ability to screen substantial parts of a genome for cross-reactivity with other targets is important to reduce such deleterious effects associated with cross-reactivity. The arrays of the present invention enable one to determine the targets to which a specific antibody binds, and to determine the extent of cross-reactivity with other polypeptides and antigens in the body.

Another use of the host cell and polypeptide arrays is for detecting and characterizing autoimmune disease and other conditions involving the immune system. In many autoimmune conditions, subjects generate an immune response against self-antigens, although the particular self-antigen may be unknown. Antisera, blood components, fluids, and cells from subjects suffering from autoimmune conditions can be applied to arrays of the present invention to determine the target antigens to which they bind. This enables the autoimmune condition to be characterized.

The phrase “specific binding-partner” as used herein indicates an agent that binds specifically to a target. Specific binding indicates that the agent can distinguish a target antigen, or epitope within it, from other non-target antigens. It is specific in the sense that it can be used to detect a target antigen above background noise (“non-specific binding”). For example, a specific binding partner can detect a specific sequence or a topological conformation. A specific sequence can be a defined order of amino acids or a defined chemical moiety (e.g., where an antibody recognizes a phosphotyrosine or a particular carbohydrate configuration, etc.) which occurs in the target antigen. The term “antigen” is issued broadly, to indicate any agent which elicits an immune response in the body. An antigen can have one or more epitopes.

Although this disclosure may be written in terms of antibodies, these are only exemplary, and any specific-binding partner can be identified in accordance with the present invention.

Arrays

The present invention provides expression clones arrays that, e.g., comprise a library of host cell expression clones, wherein each expression clone member is a host cell comprising an expressible polynucleotide (e.g., a human cDNA), and is producing a polypeptide coded for by said polynucleotide, wherein each expression clone member is located at a discrete position in an array, and wherein said library comprises a defined number of unique loci of a mammalian genome. The term “array” indicates that a plurality of expression clones are present in a single unit. The unit can be a multi-plate assembly (e.g., 96-well, 384-well, etc.); glass slides; micro-wells etched on to glass slides; membranes (nitrocellulose, nylon, etc); beads; microbeads; and other solid supports, such as those described below. A unit can also comprise multiple separate containers (e.g. tubes), where each container contains at least one expression clone. Host cell arrays can be provided in any desired format, including as live, fixed, permeabilized, lysed, frozen (e.g., in PEG, glycerol, or other cryoprotectant), etc., cells.

The term “library” is used to indicate the collection or set of host cell expression members which comprise the expression clone array. As explained in more detail below, the library can comprise clone members which are representative of a defined number of unique loci of a mammalian genome (e.g., human genome, mouse genome, monkey genome, etc), e.g., which are representative of the whole genome, or which are representative of a functional family of genes (e.g., transmembrane), or which have a functional or structural theme.

A library can comprise at least one representative for substantially all the genes in the human genome, or defined percentages of it, e.g., at least 20, 25, 30, 35, 40, 45, 50, 55, 60, 65, 70, 75, 80, 85, 90, 95, 97, 99% or more (and values in between). For example, the NCBI maintains the Reference Sequence (RefSeq) collection that provides a comprehensive, integrated, non-redundant set of sequences from the human genome. The collection is curated and continually updated. See, e.g., Pruitt K D, Katz K S, Sicotte H, Maglott D R, Trends Genet. 2000 January;16(1):44-47; Pruitt K D, Maglott D R, Nucleic Acids Res 2001 Jan. 1; 29(1):137-140; The NCBI handbook [Internet]. Bethesda (MD): National Library of Medicine (US), National Center for Biotechnology Information, 2002 Oct. Chapter 17, The Reference Sequence (RefSeq) Project. Available from http://ncbi.nlm.nih.gov/entrez/query.fcgi?db=Books (accessed Sep. 7, 2004). Thus, the RefSeq can be used to determine the number of available unique gene loci, and a library can comprise a defined percentage of its sequences. Additionally, loci not yet included in RefSeq can also be used. These can be listed in any public database, including, but not limited to, GenBank, SwissProt, GenSeq, EMBL, UniProt, ASD, IMGT, IPD, IPI, etc. See, also, Nature 431, 931-945 (21 Oct. 2004) and other articles in that issue which describe the number of human genes.

A library can also be defined by how many unique loci it comprises. A “locus” or “gene locus” refers to a distinct position on a chromosome. A gene locus is precisely mapped by nucleotide sequence to a defined chromosomal region within the genome that includes all possible exons that can be spliced together. More than one transcript can originate from a single genomic locus because of alternative exon usage and/or differential splicing. Thus, each unique gene locus can be represented by multiple expression clones, each containing a polynucleotide for a different transcript originating from the same unique gene locus.

For instance, a library can comprise polynucleotides (e.g., a cDNA, genomic DNA, etc.) from a defined or specified number of unique loci, such as at least 12,000; 13,000; 14,000; 15,000; 16,000; 17,000; 18,000; 19,000; 20,000; 21,000; 22,000; 24,000; 26,000; 28,000, 30,000, unique loci, etc. The corresponding sequences can be obtained from the publicly available RefSeq collection or from other publicly available databases. Sequences can be downloaded from NCBI at ftp://ncbi.nlm.nih.gov/refseq/release/(accessed Sep. 7, 2004). See, also, Nature 431, 931-945 (21 Oct. 2004) and other articles in that issue which describe the number of human genes.

Expression clone libraries of the present invention can also be organized into subsets based on any feature of a gene, or a polypeptide encoded by it. For example, genes can be divided into groups based on, structural, functional, temporal (e.g., when the gene or protein is expressed), or spatial (e.g., where the protein is localized in the cell or tissue) characteristics.

Examples include, but are not limited to, transmembrane (plasma membrane); G-protein coupled receptors; G-protein coupled receptors, non-olfactory; G-protein coupled receptors, olfactory; hormone receptors; steroid hormone receptors; neurotransmitter receptors; enzymes; kinases; cytoplasmic; organellar, nuclear; nuclear membrane; endoplasmic reticulum; mitochondrial; lysosomal; cytoskeleton; immune system; tissue type (e.g., breast, prostate, brain, heart, etc); ion channels; nuclear hormone receptors, cytochrome P450; phosphatases; proteases; phosphodiesterases; protein trafficking; ATP-binding cassette (ANC); cytokines; homeobox and HOX genes; integrins; transporters; DexH/D protein family (RNA metabolism), etc.

Host cell arrays can be produced according to any suitable method. For example, host cells can be distributed into multi-well plates, and then transformed with a polynucleotide according to conventional methods. In addition, microarrays of cells expressing polynucleotides can be created, e.g., according to Ziauddin and Sabatini (Nature, 411, 107-110, 3 May 2001), where cDNAs are printed on printed onto a glass slide, exposed to a transfection reagent (e.g., a lipid), and then covered with adherent mammalian cells.

For many purposes, it may be advantageous to utilize adherent cells that can be cultured on a solid support and which remain on the support when processed to determine the presence or absence of a specific-binding partner. Adherent cells are well-known, and the surfaces can be treated accordingly to provide appropriate surfaces for adherence to take place. For instance, surfaces can be treated with poly-anionic amino acids (e.g., polylysine), collagen, integrins, gelatin, and other molecules and substances which facilitate cell adhesion.

Expression Clones

A host cell expression clone is a host cell that comprises an expressible nucleotide polynucleotide, enabling it to produce the polypeptide coded for by the polynucleotide. Any type of host cell can be utilized without limitation. These include, e.g., bacteria, yeast, eukaryotic, animal, mammalian (e.g., COS, CV1, BHK, CHO, HeLa, LTK, NIH 3T3, 293), plant, etc., cells. When a polynucleotide is “expressible,” it is operably linked to an expression control sequence (e.g., promoter) in such a way that facilitates transcription and translation of the polynucleotide's coding sequence.

Any expression control sequence can be used, including promoters, enhancers, ribosome interacting sites, polyadenylation sites, sequences that stabilize mRNA, and other sequences and/or molecules that facilitate polypeptide production in a host cell. Expression control sequences can be selected for host compatibility and any desired purpose, e.g., to achieve high copy number, high amounts, promoter induction, gene amplification, and/or controlled expression.

Promoters that can be used to drive polynucleotide expression, include, e.g., a gene's endogenous promoter, MMTV; SV40; trp, lac, tac, or T7 promoters for bacterial hosts; or alpha factor, alcohol oxidase, or PGH promoters for yeast. RNA promoters can be used to produce RNA transcripts, such as T7 or SP6. Enhancer sequences can be employed, including, enhancers from SV40, CMV, RSV, cell-type specific elements, or sequences which allow selective or specific cell expression.

A polynucleotide encoding a polypeptide can also comprise nucleic acid vector sequences, e.g., for cloning, expression, amplification, selection, etc. Any effective vector can be used. A vector is, e.g., a polynucleotide molecule that can replicate autonomously in a host cell, e.g., containing an origin of replication. Vectors can be useful to perform manipulations, to propagate, and/or obtain large quantities of the recombinant molecule in a desired host. A skilled worker can select a vector depending on the purpose desired, e.g., to propagate the recombinant molecule in bacteria, yeast, insect, or mammalian cells

The expression clone members can be located at discrete locations in an array. This indicates that the clones are arranged in an identifiable or position-addressable pattern, e.g., such as the arrays disclosed in U.S. Pat. Nos. 6,156,501, 6,077,673, 6,054,270, 5,723,320, 5,700,637, WO09919711, and WO00023803. The arrays can be located on a single matrix or plate, such as a multi-well assembly (e.g., a 96-well plate), or can comprise individual and separate containers, but part of one kit.

A polynucleotide coding for a polypeptide can be expressed in a variety of different host cell systems, depending on the desired purpose, including in animal, mammalian, insect, yeast, and bacterial systems. The invention is not limited by the system, nor by the method by which the polypeptide is introduced into a host cell.

Methods for introducing DNA into cells are well-known. See, e.g., Sambrook et al., Molecular Cloning, CSH Press, 1989; Howe, Gene Cloning and Manipulation, Cambridge University Press, 1995; Ausubel et al., Current Protocols in Molecular Biology, John Wiley & Sons, Inc., 1994-1998. These can be easily adapted to high-throughput technologies.

A polynucleotide can be introduced into the cell by any effective method including, e.g., naked DNA, calcium phosphate precipitation, electroporation, injection, DEAE, Dextran-mediated transfection, fusion with liposomes, association with agents which enhance its uptake into cells, viral transduction, etc. A cell into which a polynucleotide of the present invention has been introduced can also be referred to as a “transformed host cell.”

Once present in a host cell, the polynucleotide can be extrachromosomal or integrated into a chromosome(s) of the host cell. The polynucleotide can be stably or transiently expressed, depending on the desired purpose.

Typically, a polynucleotide can be inserted into an expression vector (see above), introduced into a desired host, and cultured under conditions effective to achieve expression of a polypeptide coded for by the polynucleotide, to search for specific binding partners. Effective conditions include any culture conditions which are suitable for achieving production of the polypeptide by the host cell, including effective temperatures, pH, medium, additives to the media in which the host cell is cultured (e.g., additives which amplify or induce expression such as butyrate, or methotrexate if the coding polynucleotide is adjacent to a dhfr gene), cycloheximide, cell densities, culture dishes, etc.

Polypeptide Detection

Any suitable methodology that can determine whether an agent reacts with a polypeptide can be used in accordance with the present invention. Useful methods include, e.g., but are not limited to, immunoassays, RIA (radioimmunassay), ELISA, (enzyme-linked-immunosorbent assay), EIA (enzyme-immunoasay), immunofluorescence, flow cytometry, histology, immunocytochemistry, electron microscopy, light microscopy, immunoprecipitation, Western blot, etc.

The term “antibody” as used herein includes antibodies obtained from both polyclonal and monoclonal preparations, as well as, the following: hybrid (chimeric) antibody molecules (see, for example, Winter et al. (1991) Nature 349:293-299; and U.S. Pat. No. 4,816,567); F(ab)₂ and F(ab) fragments; Fv molecules (non-covalent heterodimers, see, for example, Inbar et al. (1972) Proc Natl Acad Sci USA 69:2659-2662; and Ehrlich et al. (1980) Biochem 19:4091-4096); single-chain Fv molecules (sFv) (see, for example, Huston et al. (1988) Proc Natl Acad Sci USA 85:5879-5883); dimeric and trimeric antibody fragment constructs; minibodies (see, e.g., Pack et al. (1992) Biochem 31:1579-1584; Cumber et al. (1992) J. Immunology 149B:120-126); humanized antibody molecules (see, for example, Riechmann et al. (1988) Nature 332:323-327; Verhoeyan et al. (1988) Science 239:1534-1536; and U.K. Patent Publication No. GB 2,276,169, published Sep. 21, 1994); human; and, any functional fragments obtained from such molecules, wherein such fragments retain immunological binding properties of the parent antibody molecule.

Binding of antibody (or other binding molecule) can be detected routinely, e.g., by attaching a detectable marker to it, or to a second, etc., binding partner when indirect labeling methods are utilized. The detectable marker may include, but is not limited to, a chromophore, an antibody, an antigen, an enzyme, an enzyme reactive compound whose cleavage product is detectable, rhodamine or rhodamine derivative, biotin, avidin, strepavidin, a fluorescent compound, a chemiluminescent compound, such as dimethyl acridinium ester, etc.

An enzyme-immuno assay can be carried out routinely, e.g., by labeling an antibody, or other specific binding partner, to an enzyme. See, e.g., Voller, A., “The Enzyme Linked Immunosorbent Assay (ELISA),” 1978, Diagnostic Horizons 2, 1-7, Microbiological Associates Quarterly Publication, Walkersville, Md.); Voller, A. et al., 1978, J. Clin. Pathol. 31, 507-520; Butler, J. E., 1981, Meth. Enzymol. 73, 482-523; Maggio, E. (ed.), 1980, Enzyme Immunoassay, CRC Press, Boca Raton, Fla. The enzyme which is bound to the antibody can react with an appropriate substrate, such as a chromogenic substrate, in such a manner as to produce a chemical moiety that can be detected, for example, by spectrophotometric, fluorimetric or by visual means. Enzymes that can be used to detectably label the antibody include, but are not limited to, malate dehydrogenase, staphylococcal nuclease, delta-5-steroid isomerase, yeast alcohol dehydrogenase, .alpha.-glycerophosphate, dehydrogenase, triose phosphate isomerase, horseradish peroxidase, alkaline phosphatase, asparaginase, glucose oxidase, beta.-galactosidase, ribonuclease, urease, catalase, glucose-6-phosphate dehydrogenase, glucoamylase and acetylcholinesterase.

The detection can be accomplished by colorimetric methods that employ a chromogenic substrate for the enzyme. Detection may also be accomplished by visual comparison of the extent of enzymatic reaction of a substrate in comparison with similarly prepared standards. Antibodies can be directly labeled, or indirectly labeled. For example, when human antibodies are being screened, a detectably labeled anti-human antibody can be used as a universal reagent to determine the presence or absence of binding.

Detection can be accomplished using radioactive labeled antibodies (direct or indirect), where the radioactive isotope can be detected by such means as the use of a gamma counter or a scintillation counter or by autoradiography. It is also possible to label the antibody with a fluorescent compound. When the fluorescently labeled antibody is exposed to light of the proper wavelength, its presence can then be detected due to fluorescence. Among the most commonly used fluorescent labeling compounds are fluorescein isothiocyanate, rhodamine, phycoerythrin, phycocyanin, allophycocyanin, o-phthaldehyde and fluorescamine. The antibody can also be detectably labeled using fluorescence emitting metals such as those in the lanthanide series. These metals can be attached to the antibody using such metal chelating groups as diethylenetriaminepentacetic acid (DTPA) or ethylenediaminetetraacetic acid (EDTA).

The antibody also can be detectably labeled by coupling it to a chemiluminescent compound. The presence of the chemiluminescent-tagged antibody is then determined by detecting the presence of luminescence that arises during the course of a chemical reaction. Examples of useful chemiluminescent labeling compounds are luminol, isoluminol, theromatic acridinium ester, imidazole, acridinium salt and oxalate ester.

Likewise, a bioluminescent compound may be used to label the antibody of the present invention. Bioluminescence is a type of chemiluminescence found in biological systems in which a catalytic protein increases the efficiency of the chemiluminescent reaction. The presence of a bioluminescent protein is determined by detecting the presence of luminescence. Important bioluminescent compounds for purposes of labeling are luciferin, luciferase and aequorin.

Assays can be performed directly on whole cells that can be live, fixed, permeabilized, or otherwise processed to provide access to expressed proteins. Fixation can be done routinely, e.g., using any standard fixative, such as formadehyde, paraformaldehyde, glutaraldehyde, Carnoy's solution (e.g., 3:1 methanol:acetic acid), alcohol, methanol, acetone, acid alcohol (e.g., 95% ethanol, 5% acetic acid), etc. Fixed cells can be contacted with a binding partner, and the binding partner can be detected routinely, e.g., using immunofluoresence, and/or any of the techniques mentioned herein. To provide access to internal and/or otherwise inaccessible antigens, cells can further be permeabilized using various agents, including non-ionic detergents, such as Triton X-100, Brij, etc. Adherent cells can be preferably used. The substrate upon which the cells are cultured can be treated (e.g., with a collagen, a polyanionic amino acid, such as polylysine, etc.) to facilitate adherence of the cells to the substrate.

Cells, or components thereof (polypeptide and fragments thereof, and other biomolecules) can be attached to or immobilized on any type of solid support (i.e., substrate). Attachment can be covalent or non-covalent. A solid support can be any material that is an insoluble matrix and can have a rigid or semi-rigid surface. Exemplary solid supports include, but are not limited to, substrates such as nitrocellulose (e.g., in membrane or microtiter well form); polyvinylchloride (e.g., sheets or microtiter wells); polystyrene latex (e.g., beads or microtiter plates); polyvinylidine fluoride; diazotized paper; nylon membranes; activated beads, magnetically responsive beads, etc. Particular supports include plates, pellets, disks, capillaries, hollow fibers, needles, pins, solid fibers, cellulose beads, pore-glass beads, silica gels, polystyrene beads optionally cross-linked with divinylbenzene, grafted co-poly beads, polyacrylamide beads, latex beads, dimethylacrylamide beads optionally crosslinked with N—N′-bis-acryloylethylenediamine, and glass particles coated with a hydrophobic polymer.

If desired, the molecules to be added to the solid support can readily be functionalized to create styrene or acrylate moieties, thus enabling the incorporation of the molecules into polystyrene, polyacrylate or other polymers such as polyimide, polyacrylamide, polyethylene, polyvinyl, polydiacetylene, polyphenylene-vinylene, polypeptide, polysaccharide, polysulfone, polypyrrole, polyimidazole, polythiophene, polyether, epoxies, silica glass, silica gel, siloxane, polyphosphate, hydrogel, agarose, cellulose, etc.

In addition to using whole cells, cells can also be optionally lysed and antigens can be detected in the lysate. A lysate can be used directly, e.g., in immunoprecipitation, or the components of it (polypeptides, etc,) can be immobilized on a solid substrate, and then processed for detection of a binding partner.

Methods of the present invention for screening for specific-binding partners that bind to polypeptides, comprising: a) contacting members of a library of host cell expression clones with at least one specific-binding partner, wherein each expression clone member is a host cell comprising an expressible human cDNA, and is producing a polypeptide coded for by said human cDNA, wherein each expression clone member is located at a discrete position in an array, wherein said library comprises a defined number of unique loci of a mammalian genome; and b) detecting the presence or absence of specific-binding partner binding to said polypeptide. These methods can be carried out in accordance with any suitable format for detection, including ELISA, EIA, and other formats described above. Contact between the polypeptide and binding partner can be under conditions which are effective for said binding partner to bind specifically to said polypeptide. Effective conditions include any conditions that useful to facilitate the relevant type of binding, e.g., protein and antibody. These include, temperature, salt, buffer type, presence of detergent or other additives, etc.

The arrays of the present invention can be used to identify polypeptide substrates, where protein arrays can be adapted to any routine enzyme assay. For instance, kinase assays can utilize radioactive ATP substrate, and after washing to remove excess ATP, the arrays can be scanned for the presence of radioactivity, indicating the transfer of a radioactive phosphorus on to an expressed protein.

The topic headings set forth above are meant as guidance where certain information can be found in the application, but are not intended to be the only source in the application where information on such topic can be found.

Reference Materials

For other aspects of the polynucleotides, reference is made to standard textbooks of molecular biology. See, e.g., Hames et al., Polynucleotide Hybridization, IL Press, 1985; Davis et al., Basic Methods in Molecular Biology, Elsevir Sciences Publishing, Inc., New York, 1986; Sambrook et al., Molecular Cloning, CSH Press, 1989; Howe, Gene Cloning and Manipulation, Cambridge University Press, 1995; Ausubel et al., Current Protocols in Molecular Biology, John Wiley & Sons, Inc., 1994-1998.

From the foregoing description, one skilled in the art can easily ascertain the essential characteristics of this invention, and without departing from the spirit and scope thereof, can make various changes and modifications of the invention to adapt it to various usages and conditions. The entire disclosure of all applications, patents and publications, cited above and in the figures are hereby incorporated by reference in their entirety.

What we claim:

1. A method of screening for agents that bind to polypeptides, comprising:
a) contacting members of a library of host cell expression clones with at least one agent,
wherein each expression clone member is a host cell comprising an expressible human cDNA, and is producing a polypeptide coded for by said human cDNA,
wherein each expression clone member is located at a discrete position in an array,
wherein said library comprises a defined number of unique loci of a human genome; and
b) detecting the presence or absence of agent specifically binding to said polypeptide.

2. A method of claim 1, wherein said each discrete position contains a single expression clone member.

3. A method of claim 1, wherein said each discrete position contains a single and different expression clone member from other positions in the array.

4. A method of claim 1, wherein said library contains a substantially equal number of expression clone members representing each gene.

5. A method of claim 1, wherein said library contains 1-10 copies of each expression clone member.

6. A method of claim 1, wherein said library comprises representatives of at least 12,000 unique loci.

7. A method of claim 6, wherein said unique loci are RefSeq loci.

8. A method of claim 1, wherein further comprising producing said cDNA from a reverse-transcriptase process and without polymerase chain reaction.

9. A method of claim 1, wherein said cDNA comprises a continuous open reading frame with no in-frame heterologous coding sequences.

10. A method of claim 1, where said host cell expression clone member is a host cell which is a mammalian host cell.

11. A method of claim 1, where said host cell expression clone member is a host cell which is a yeast or bacterial host cell.

12. A method of claim 1, wherein said host cell is present in the array as a lysate.

13. A method of claim 1, wherein said host cell is intact and permeabilized.

14. A method of claim 1, wherein said host cell expression members are arrayed in a multi-well plate comprising a plurality of compartments, or on a surface.

15. A method of claim 1, wherein said agent is an antibody.

16. A method of claim 1, wherein said agent is an enzyme.

17. An expression clone array, comprising a library of host cell expression clones,
wherein each expression clone member is a host cell comprising an expressible human cDNA, and is producing a polypeptide coded for by said human cDNA,
wherein each expression clone member is located at a discrete position in an array, and
wherein said library comprises a defined number of unique loci of a human genome.

18. An array of claim 17, wherein said unique loci comprise transmembrane proteins.

19. An array of claim 17, wherein said library comprises representatives of at least 12,000 unique loci.

20. An array of claim 19, wherein said unique loci are RefSeq loci.
